(19) United States
(12) Patent Application Publication
(10) Pub. No.: US 2015/0086650 A1
(43) Pub. Date: Mar. 26, 2015

(54) Pre-Harvest Treatment

(71) Applicant: Natural Biotechnology SPRL, Courcelles (BE)

(72) Inventor: Jeffrey Ian Dodd, Lancashire (GB)

(73) Assignee: Natural Biotechnology SPRL, Courcelles (BE)

(21) Appl. No.: 14/387,223

(22) PCT Filed: Mar. 21, 2013
(86) PCT No.: PCT/GB2013/000126

§ 371 Date: Sep. 22, 2014

(30) Foreign Application Priority Data
Mar. 21, 2012 (GB) 1204981.3

(51) Int. Cl. A01N 59/02; A01N 61/00

(52) U.S. Cl. CPC A01N 59/02; A01N 61/00
USPC 424/709

(57) ABSTRACT

There is described a method of treating a crop for the alleviation or prevention of a pest infestation, said method comprises the pre-harvest application to the crop of a composition comprising an acidulant

### FIELD OF THE INVENTION

The present invention relates to a novel use of compositions and to novel methods related thereto.

More particularly, the invention relates the use of certain compositions for pre-harvest protection of crops, such as potatoes, tomatoes, etc.

### BACKGROUND OF THE INVENTION

Certain food crops, such as potatoes, tomatoes, etc. are particularly susceptible to attack by pests in the 2 to 4 weeks prior to harvest, as the plant and the crop are approaching maturity or ripening.

Crops such as potatoes, tomatoes, etc are especially susceptible to attack by mites, such as the broad mite, Polyphagotarsonemus latus.

The broad mite has a large host range including 60 families of plants. Its vegetable hosts include beet, beans, cucumber, eggplant, pepper, potato and tomato. Damage to a crop is usually caused by secretion of a plant growth regulator or toxin as the mite feeds, and significant damage can occur at very low pest density. Symptoms include leaf and fruit distortions, shortening of internodes, blistering, shriveling and curling of leaves, and leaf discoloration. The crop may be deformed, split or russeted. Infestations in crops such as tomatoes can cause a bronzing of terminal growth and are frequently a characteristic ‘s’-shaped twisting of the main stem in leaves. When combined with the difficulty in detecting mites, control measures are difficult to implement.

The mite is generally difficult to control as it is insusceptible to some chemicals, such as dinitrophenol compounds and synthetic pyrethroids. Conventional treatment comprises the application of a contact acaricide, for example, organophosphates, such as, diazinon, or organ chlorine pesticides, such as, endosulfan and dicofol. However, the use of such pesticides is increasingly controversial due to the threat they pose to human or animal health.

Phytophthora Infestans (P. Infestans) is an oomycetes that causes the serious potato disease known as Late Blight or potato blight. Late blight was a major culprit in the 1840s European, the 1845 Irish and 1846 Highland potato famines. The organism can also infect tomatoes and some other members of the Solanaceae.

Close to 2 million hectares of potatoes are grown in Europe, and the harvest represents a value of about 6 billion Euros. According to estimates, late blight causes 1 billion Euros of damage in Europe. This damage consists of costs for controlling the disease (costs for purchasing fungicides, plus costs for spray operations) and the costs that result from reductions in harvest and losses during storage. Around the world the disease causes around US$6 billion=ε7.80 billion of damage to crops each year.

Phytophthora infestans spores develop on the leaves, spreading through the crop when temperatures are above 10° C. (50° F.) and humidity is over 75%-80% for 2 days or more. Rain can wash spores into the soil where they infect young tubers. Spores can [symbol] distances on the wind.

The spores of this oomycetes remaining over-winter on infected tubers, particularly those that are left in the ground after the previous year's harvest, spread rapidly in warm and wet conditions. This can have devastating effects by destroying entire crops.

The early stages of blight are easily missed, and not all plants are affected at once. Symptoms include the appearance of dark blotches on leaf tips and plant stems. White mould will appear under the leaves in humid conditions and the whole plant may quickly collapse. Infected tubers develop grey or dark patches that are reddish brown beneath the skin, and quickly decay to a foul-smelling mush caused by the infestation of secondary soft bacterial rots. Seemingly healthy tubers may rot later when in store.

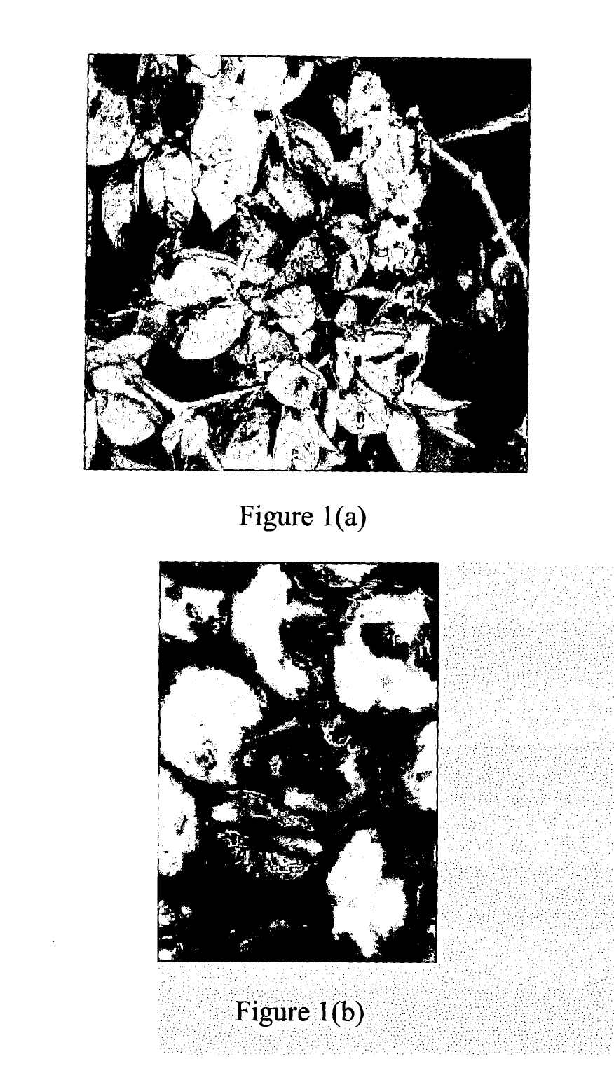

The result of Phytophthora in affected Potato plants and tubers is illustrated in FIGS. 1(a) and 1(b).

Alternaria solani (A. solani) a fungal pathogen, is the cause of Early Blight, and is the most destructive disease of tomatoes in the tropical and subtropical regions. Each 1% increase in intensity can reduce yield by 1.36%, and complete crop failure can occur when the disease is most severe. Yield losses of up to 79% have been reported in the USA, of which 20-40% is due to seedling losses (i.e., collar rot) in the field.

A. solani is also one of the most important foliar pathogens of potato. In the USA yield loss estimates attributed to foliar damage, which results in decreased tuber quality and yield reduction, can reach 20-30%. In storage, A. solani can cause dry rot of tub reduce storage length, which both of which diminish the quantity and quality of marketable tubers.

Because A. solani is one of numerous tomato/potato pathogens that are typically controlled with the same products, accurately estimating both the total economic loss and the total expenditure on fungicides for control of early blight is difficult. Best estimates suggest that total annual global expenditures on fungicide control of A. solani is approximately US$77 million: US$32 million for tomatoes and US$45 million for potatoes.

### Early and Late Blight:

### Early Blight

Alternaria solani pathogen produces distinctive “bulls-eye” patterned leaf spots and can also cause stem lesions and fruit rot on tomato and tuber blight on potato. Despite the name “early,” foliar symptoms usually occur on older leaves. If uncontrolled, early blight can cause significant yield reductions. Primary methods of controlling this disease include preventing long periods of wetness on leaf surfaces and applying fungicides.

### 1. Geographically

A. solani is also present in most potato production regions every year but has a significant effect on yield only when frequent wetting of foliage favour's symptom development.

### 2. Mode of Infection

### On Potatoes:

In potato, primary damage by A. solani is attributed to premature defoliation of potato plants, which results in tuber yield reduction. Initial infection occurs on older leaves, with concentric dark brown spots developing mainly in the leaf centre.

The disease progresses during the period of potato vegetation, and infected leaves turn yellow and either dry out or fall off the stem. On stems, spots are gaunt with no clear contours (as compared to leaf spots). Tuber lesions are dry, dark and pressed into the tuber surface, with the underlying flesh turning dry, leathery and brown. During storage, tuber lesions may enlarge and tubers may become shrivelled. Disease severity due to A. solani is highest when potato plants are injured, under stress or lack proper nutrition. High levels of nitrogen, moderate potassium and low phosphorus in the soil can reduce susceptibility of infection by the pathogen.

On Tomatoes:

On tomato, foliar symptoms of A. solani generally occur on the oldest leaves and start as small lesions that are brown to black in colour. These leaf spots resemble concentric rings—a distinguishing characteristic of the pathogen—and measure up to 1.3 cm (0.51 inches) in diameter. Both the area around the leaf spot and the entire leaf may become yellow or chlorotic.

Under favourable conditions (e.g. warm weather with short or abundant dews), significant defoliation of lower leaves may occur, leading to sunscald of the fruit. [symbol] progresses, symptoms may migrate to the plant stem and fruit. Stem lesions are dark, slightly sunken and concentric in shape. Basal girdling and death of seedlings may occur, a symptom known as collar rot.

In fruit, A. solani invades at the point of attachment to the stem as well as through growth cracks and wounds made by insects, infecting large areas of the fruit. Fruit spots are similar in appearance to those on leaves—brown with dark concentric circles. Mature lesions are typically covered by a black, velvety mass of fungal spores that may be visible under proper light conditions.

### Disease Cycle

Alternaria solani is a deuteromycete with a polycyclic life cycle. Alternaria solani reproduces asexually by means of conidia.

The life cycle starts with the fungus overwintering in crop residues or wild members of the Solanaceae family, such as black nightshade. In the spring, conidia are produced. Multicellular conidia are splashed by water or by wind onto an uninfected plant. The conidia infect the plant by entering through small wounds, stomata, or direct penetration.

Infections usually start on older leaves close to the ground. The fungus takes time to grow and eventually forms a lesion. From this lesion, more conidia are created and released. These conidia infect other plants or other parts of the same plant within the same growing season. Every part of the plant can be infected and form lesions. This is especially important when fruit or tubers are infected as they can be used to spread the disease.

In general, development of the pathogen can be aggravated by an increase in inoculum from alternative hosts such as weeds or other Solanaceous species. Disease severity and prevalence are highest when plants are mature.

### Environment:

Alternaria solani spores are universally present in fields where host plants have been grown.

Free water is required for Alternaria spores to germinate; spores will be unable to infect a perfectly dry leaf. Alternaria spores germinate within 2 hours over a wide range of temperatures but at 26.6-29.4° C. (80-85° F.) may only take ½ hour. Another 3 to 12 hours are required for the fungus to penetrate the plant depending on temperature. After penetration, lesions may form within 2-3 days or the infection can remain dormant awaiting proper conditions [15.5° C. (60° F.) and extended periods of wetness]. Alternaria sporulates best at about 26.6° C. (80° F.) when abundant moisture (as provided by rain, mist, fog, dew, irrigation) is present. Infections are most prevalent on poorly nourished or otherwise stressed plants.

### Late Blight

P. infestans is still a difficult disease to control today by ordinary methods. There are many options in agriculture for the control of both (1) damage to the foliage and (2) infections of the tuber. Potatoes grow throughout the season, but it is estimated the tubers stop growing when 75% of the canopy has been destroyed.

### 1. Mode of Infection

### On Potatoes and Tomatoes

The fungus is dispersed by wind-borne sporangia, which are produced on branched hyphae (sporangiophores) that emerge from the stomata of infected leaves in humid conditions (see diagram). When the sporangia land on a new leaf surface they usually undergo internal cleavage of the protoplasm to produce motile, un-nucleate zoospores, which locate the leaf stomata, where they encyst and germinate to initiate infection. Within the leaf, the hyphae produce haustoria in the individual host cells so P. infestans grows initially as a biotroph. However, the infected tissues soon die, and the fungus then spreads through the leaf as a necrotroph.

If P. infestans gets established on the potato foliage then sporangia can be washed down into the soil to infect the tubers, or the tubers can be contaminated with sporangia during crop harvesting. This can lead to rotting of the tubers during storage, and carry-over of inoculum from one season to the next.

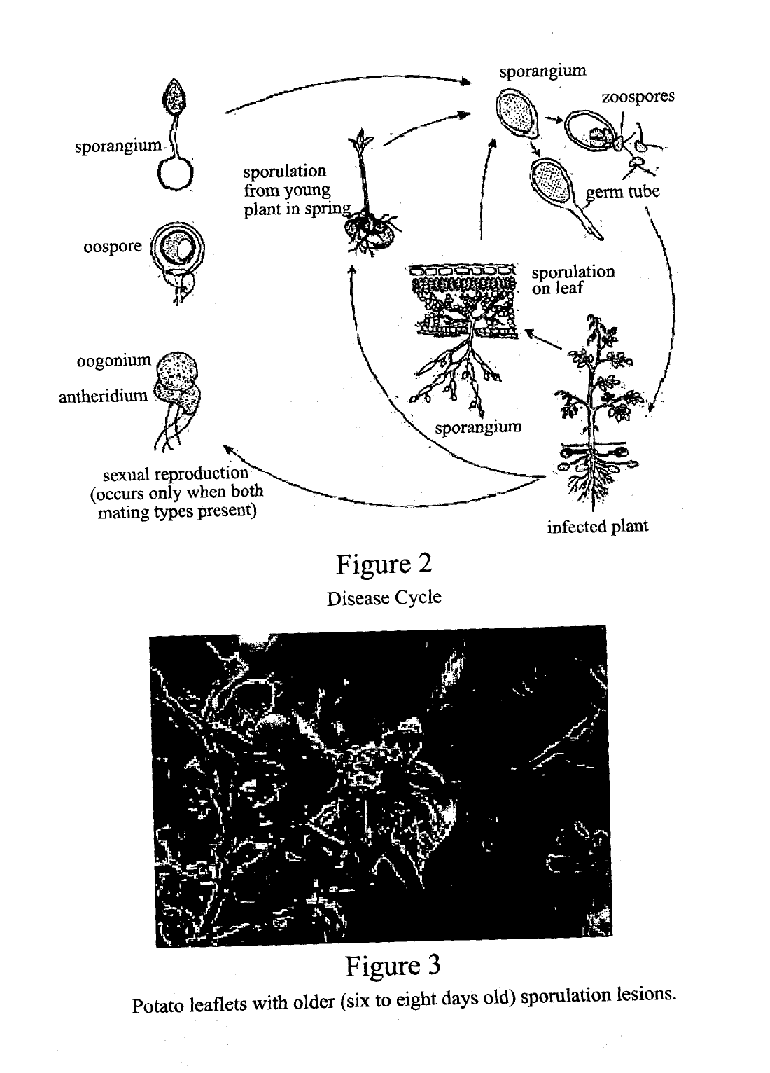

The Disease Cycle is illustrated in FIG. 2.

P. infestans is usually dispersed aerially one to several miles from the overwintering site to living potato or tomato foliage via sporangia which can survive exposure to dry, sunny conditions for up to an hour and even longer under cloudy conditions. Sporangia can germinate within a few hours after landing on potato or tomato foliage if free moisture (e.g. dew, rainfall, sprinkler irrigation, fog) is present. Germination takes place either indirectly via zoospores or directly via a germ tube that penetrates into foliage, stems, [symbol] infections. Infections are visible as small lesions after three to four days. Necrotic areas on some lesions are only 1 to 2 mm in diameter. Lesions enlarge as the pathogen grows through the tissues, and the pathogen can sporulate from older lesions when the environment is favourable (leaf wetness for more than 10 to 12 hours at moderate temperatures [60°-70° F.]). Sporulation may occur on lesions that are only four to six days old. Under dry conditions no sporulation occurs and the lesion has a brown dead centre, surrounded by host tissue that has collapsed and appears either water soaked, grey-green, or yellowed. Both tomato and potato fruits are susceptible. Their stems may be infected (and stem lesions are capable of producing sporangia for a longer time than can lesions on leaves.

Potato leaflets with older (six to eight days old) sporulation lesions are illustrated in FIG. 3.

Disease development (growth and reproduction of the pathogen) is favoured by moderate temperatures (60°-80° F.) and wet conditions. It can develop in very warm daytime temperatures (ca. 95° F.) if conditions are extremely wet and night temperatures are moderate (60°-75° F.). Epidemics can be rapid and devastating because of the high reproductive potential of this pathogen. Individual lesions can produce 100,000 to 300,000 sporangia per day. Each sporangium is capable of initiating a new infection that will become visible within three to four days and produce sporangia within another day or two under optimal conditions. Thus rapid reproduction of the pathogen and destruction of leaflets can defoliate potatoes or tomatoes and completely destroy healthy fields in a short time. Such epidemics result from many sequential cycles of infections: every lesion produces many sporangia, each of which can be dispersed to a new leaflet to initiate a new infection, which in turn can produce many sporangia, and so on.

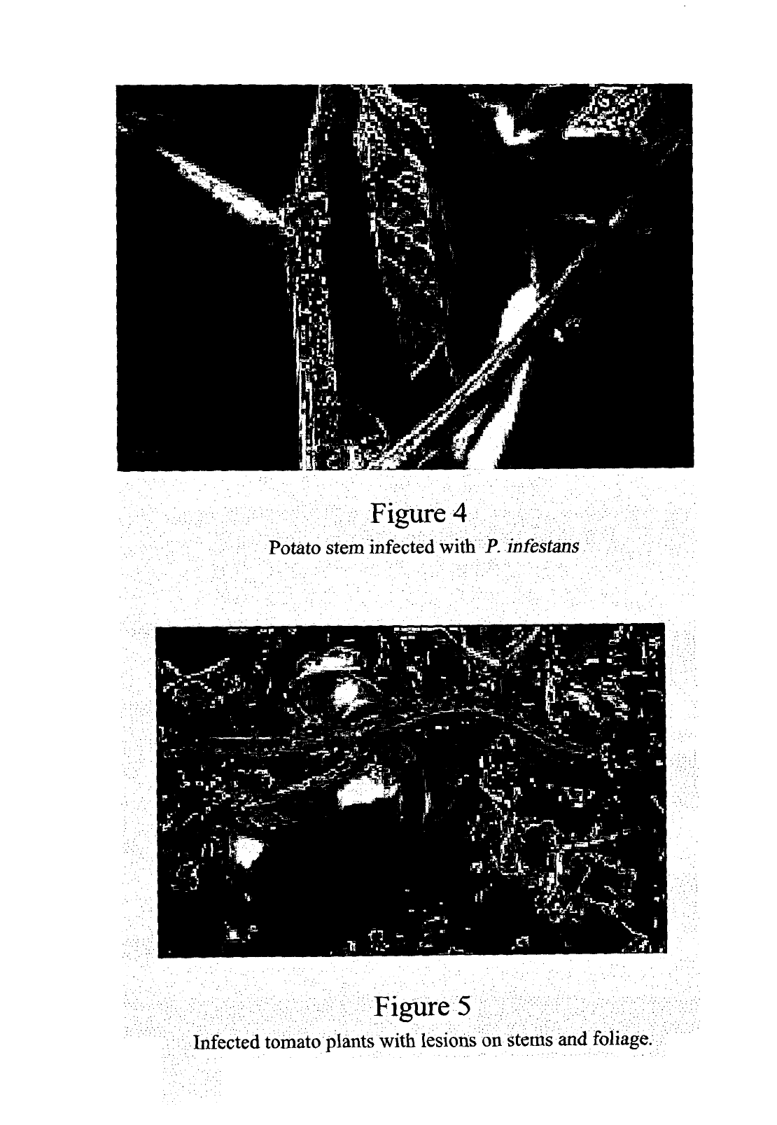

Potato stem infected with P. infestans illustrated in FIG. 4.

Infected tomato plants with lesions on stems and foliage illustrated in FIG. 5.

### Existing Chemical Control:

There are numerous fungicides on the market for controlling early blight. Some of the fungicides on the market are Azoxystrobine, Cymoxanil, Furalaxyl Pyraclostrobin, Bacillus subtilis, Chlorothalonil, Copper products, hydrogen dioxide, mancozeb, potassium bicarbonate, and Ziram™ (zinc dimethyldithiocarbamate). Specific spraying regimens are found on the label. Labels for these products should be read carefully before applying.

### Cymoxanil

Cymoxanil was first introduced in 1977. It is an acetimide compound used as both a curative and preventative foliar fungicide. In Europe it is being sold for use on grapes, potatoes, tomatoes, hops, sugar beets and other vegetable crops. Cymoxanil is currently not registered in the USA.

The mode of action of Cymoxanil is as a local systemic. It penetrates rapidly and when inside the plant, it cannot be washed off by rain. It controls diseases during the incubation period and prevents the appearance of damage on the crop. The fungicide is primarily active on fungi belonging to the Peronosporales order: Phytophthora, Plasmopara, and Peronospora.

### Azoxystrobine

Azoxystrobine was first marketed in 1998 and is a systemic, broad-spectrum [symbol] activity against the four major groups of plant pathogenic fungi including Ascomcetes (e.g. powdery mildews), Basidiomycetes (e.g. rusts), Deuteromycete (e.g. rice blast) and oomycetes (e.g. downy mildew). It inhibits spore germination and mycelia growth. It has worldwide uses on cereals, vines, rice, citrus, potatoes and tomatoes. In 1999, Azoxystrobine was the leading proprietary fungicide worldwide with sales of US$415m and is now a world market leader in cereals.

It was given provisional approval for use in the UK on some fungal diseases of wheat and barley in 1997, subject to approval at EU level. It was given Annex 1 approval in the EU in 1998 as a fungicide for use on cereals and vines. In the UK it is marketed as Amistar™, and in the USA as Heritage™.

Azoxystrobin is classified by the World Health Organisation as ‘slightly hazardous’ (Class III). The acute oral LD50 (the dose required to kill half a population of laboratory animals) is more than 5,000 mg/kg for rats.

It is an irritant to skin and may cause sensitization. It is also classed as toxic by inhalation.

### Use of Fungicides

Fungicides for the control of potato blight are normally only used in a preventative manner, sometimes in conjunction with disease forecasting. In susceptible varieties, fungicide applications may be needed weekly. An early spray is most effective.

Copper is a broad-spectrum fungicide which acts as a protectant—it must be applied to prevent disease. It has been superseded by modern systemic fungicides, wh [symbol] the plant and can both protect and eradicate existing infections. These fungicides are much more specific in their mode of action. Chief among these for control of potato blight are the acylalanine fungicides such as metalaxyl and furalaxyl. They act specifically on the RNA polymerase of Phytophthora and closely related fungi. However, resistance to them can develop quickly in the pathogen population—it requires only a single gene mutation leading to a minor change in the RNA polymerase molecule. In many parts of the world, P. infestans is now resistant to these fungicides.

Control of potato blight traditionally relied on copper-based fungicides such as Bordeaux mixture (consisting of copper sulphate and calcium oxide). However, copper is potentially phytotoxic,

Therefore, there is a need for a safe pre-harvest treatment for crops that are susceptible to attack by pests, such as the broad mite and/or Phytophthora Infestans and/or Alternaria solani.

### SUMMARY OF THE INVENTION

We have now developed a novel treatment that overcomes the problems posed by conventional treatments for pest infestations of arachnids, such as, mites, e.g. broad mites, Polyphagotarsonemus latus and/or fungal infestations, such as Phytophthora Infestans and/or Alternaria solani.

Therefore, according to a first aspect of the invention there is provided a method of treating a crop for the alleviation or prevention of a pest infestation, said method comprises the pre-harvest application to the crop of a composition comprising an acidulant.

The method of the invention generally comprises applying to the crop the composition as hereinbefore described about 2 to 6 prior to harvest, preferably about 3 to 5 weeks prior to harvest for example, about 4 weeks prior to harvest. Prevention of infestations can be achieved by treating plants/crops with the composition of the invention regularly as a prophylactic measure.

The method of the invention may comprise treating a crop for the alleviation or prevention of an infestation of arachnids, such as, mites, e.g. broad mites.

Alternatively, the method of the invention may comprise treating a crop for the alleviation or prevention of a fungal infestation, such as, such as Phytophthora Infestans and/or Alternaria solani.

Additionally, compositions of the invention have been shown to be particularly effective in treating or preventing broad mite infestation, and thus the present invention also provides a method of treating or preventing such infestations.

The acidulant used in the method of the invention desirably comprises a solution, e.g. an aqueous solution.

The aqueous solution will generally be applied by spraying the solution on the crop prior to harvesting.

Arachnid infestations which may be prevented according to the present invei [symbol] example, infestations of mites, spiders and ticks.

In one embodiment the present invention provides a method of preventing a plant infestation, for example by broad mites. Administration may suitably be by spraying or otherwise spreading the composition onto an arachnid population or fungal infestation or by spraying onto a plant leaf which may then be ingested by the arachnid. Alternatively, an object, e.g. a crop, infested with the arachnid or fungus may be immersed in the composition.

According to this aspect of the invention the acidulant is selected from those that will reduce the pH of the aqueous solution to at least about 3 or less. In a preferred aspect of the invention the acidulant will reduce the pH to at least about 2.3 or less, preferably 2 or less, preferably to about 1.8 or less and most preferably to about 1.4 or less.

The concentration of the acidulant may vary depending upon, inter alia, the nature of the acidulant, the nature of crop being treated, etc. However, the concentration of acidulant may be from about 0.1% to about 25% (w/v), preferably from about 0.1% to about 6% (w/v), preferably from about 0.1% to about 4% (w/v), preferably from about 1% to about 4% (w/v).

In a preferred aspect of the method of the invention the acidulant is a modified acidified salt. The acidified salt may be acidified sodium chloride, e.g. bisulphate of soda/sodium bisulphate/sodium hydrogen sulphate (NaHSO₄). Preferably, the composition may include an antioxidant/reducing agent, such as ascorbic acid. Desirably the antioxidant/reducing agent will be a free radical scavenger which can prevent oxidation by altering the REDOX potential of the system and can reduce undesirable oxidative products.

The composition may include one or more enzyme inhibitors. A variety of enzyme inhibitors may be utilised in the method of the invention, however, preferentially the enzyme inhibitor comprises a combined treatment of an acidulant and an antioxidant/reducing agent. In the combined treatment according to this aspect of the invention may comprise the use separately, sequentially or simultaneously of an acidulant and an antioxidant/reducing agent.

However, a variety of antioxidants/reducing agents may be used. Thus, specific antioxidants/reducing agents which may be mentioned include, but shall not be limited to, ascorbic acid (vitamin C) and especially salts thereof, such as alkali metal salts, e.g. sodium ascorbate; kojic acid (5-hydroxy-2-(hydroxymethyl)-4H-pyran-4-one) and salts thereof; erythorbic acid and especially salts thereof, such as alkali metal salts, e.g. sodium erythorbate; phenolic antioxidant carboxylic acids, such as a rosmarinic acid ([[3-(3,4-dihydroxyphenyl)-1-oxo-2E-propenyl]oxy]-3,4-dihydroxy-benzenepropanoic acid) and optionally salts thereof, such as alkali metal salts.

The amount of antioxidant/reducing agent, as hereinbefore described, may vary and may be from about 0.25% (w/v) to about 10% (w/v), preferably from about 0.5% (w/v) to about 5% (w/v), more preferably from about 1% (w/v) to about 2% (w/v).

The acidulant, e.g. sodium bisulphate or a combination of sodium bisulphate and an antioxidant/reducing agent, such as ascorbic acid, may be prepared in a diluent. Whilst a variety of diluents may be used, a preferred diluent comprises one or more of a flavouring and preservative agent, such as, citric acid, and optionally salts thereof, or succinic acid, and optionally salts thereof; a surfactant, such as, an alkyl (alkyl C1 to 20, [symbol] glucoside; and a pH regulator, such as, lactic acid, and optionally salts thereof. Preferably, the diluent comprises a blend of two or more of a flavouring and preservative agent(s), a surfactant and a pH regulator. Most preferably the diluent comprises a blend of two or more of succinic acid, citric acid, an alkyl glucoside and lactic acid, and optionally salts thereof, and more preferably a blend comprising each of succinic acid, citric acid, an alkyl glucoside and lactic acid, and optionally salts thereof.

The modified bisulphate of soda may function as an acidulant and thereby has a denaturing effect on microorganisms, for example, by reducing the pH to below the level at which is required to prevent mite infestation.

In the method of the invention the composition may, for example, be applied at a rate of about 2 litres per hectare of crop, depending upon, inter alia, the concentration of the composition, etc.

According to this aspect of the invention the method may comprise the treatment of a potato crop.

According to this aspect of the invention the method may comprise the treatment of a tomato crop.

In a preferred embodiment of the invention the method comprises the pre-harvest application to the crop of a composition comprising about 10 to about 40% w/w sodium hydrogen sulphate; about 5 to about 20% w/w lactic acid; about 2 to about 15% w/w citric acid and about 5 to about 20% w/w glucoside surfactant.

According to a further aspect of the invention there is provided a composition suitable for the treatment or prevention of a pest infestation of a crop comprising an acidulant present in an amount from about from about 0.1% to about 25% (w/v).

According to this aspect of the invention the composition may be suitable for the treatment or prevention of an infestation of arachnids, such as, mites, e.g. broad mites.

Alternatively, the composition may be suitable for the treatment or prevention of a fungal infestation, such as, such as Phytophthora infestans and/or Alternaria solani.

According to this aspect of the invention the acidulant is a modified acidified salt as hereinbefore described. Preferably, the modified acidified salt in the composition of the invention may be a mixture of bisulphate of soda and an antioxidant/reducing agent, such as ascorbic acid.

However, a variety of antioxidants/reducing agents may be used. Thus, specific antioxidants/reducing agents which may be included in the composition of the invention, are one or more of ascorbic acid (vitamin C) and especially salts thereof, such as alkali metal salts, e.g. sodium ascorbate; kojic acid (5-hydroxy-2-(hydroxymethyl)-4H-pyran-4-one), and salts thereof; erythorbic acid and especially salts thereof, such as alkali metal salts, e.g. sodium erythorbate; phenolic antioxidant carboxylic acids, such as a rosmarinic acid ([[3-(3,4-dihydroxyphenyl)-1-oxo-2E-propenyl]oxy]-3,-dihydroxy-benzenepropanoic acid) and optionally salts thereof, such as alkali metal salts.

In the composition of the invention the antioxidant/reducing agent, such as ascorbic acid, may comprise a diluent. Whilst a variety of diluents may be used, a preferred diluent comprises one or more of a flavouring and preservative agent, such as, citric acid, and optionally salts thereof, or succinic acid, and optionally salts thereof; a surfactant, such as, an alkyl (alkyl C1 to 20 preferably C8) glucoside; and a pH regulator, such as, lactic acid, and optionally salts thereof. Preferably, the diluent comprises a blend of two or more of a flavouring and preservative agent, a surfactant and a pH regulator. Most preferably the diluent comprises a blend of two or more of succinic acid, citric acid, an alkyl glucoside and lactic acid, and optionally salts thereof, and more preferably a blend comprising each of succinic acid, citric acid, an alkyl glucoside and lactic acid, and optionally salts thereof.

In a preferred embodiment of the invention the composition comprises about 10 to about 40% w/w sodium hydrogen sulphate; about 5 to about 20% w/w lactic acid; about 2 to about 15% w/w citric acid and about 5 to about 20% w/w glucoside surfactant. For example, the composition comprises about 25 40% w/w sodium hydrogen sulphate; about 12½% w/w lactic acid; about 6½% w/w citric acid and about 12½% w/w glucoside surfactant.

According to a yet further aspect of the invention there is provided a kit suitable for the treatment or prevention of a pest infestation of a crop, the kit comprising a low concentration acidulant as hereinbefore described.

According to this aspect of the invention the kit may be suitable for the treatment or prevention of an infestation of arachnids, such as, mites, e.g. broad mites.

Alternatively, the kit may be suitable for the treatment or prevention of a fungal infestation, such as, such as Phytophthora Infestans and/or Alternaria solani.

In the composition or kit as herein before described, an optional component may comprise a chelating agent. Thus, as hereinbefore described the chelating agent should have an affinity to copper or iron and salts thereof. It will be understood that more than one chelating agent may be present, for example, a copper selective chelating agent may be combined with an iron selective chelating agent. The chelating agent may also be an agent, e.g. an acidulant, which may reduce the pH of the environment, such as, an organic acid selected from one or more of citric acid, lactic acid, succinic acid or tannic acid or a combination thereof, and optionally salts thereof.

In the kit of the present invention as hereinbefore described the chelating agent may, for example, be present in a single composition or solution, or it may be separate.

In the composition or kit as hereinbefore described, the acidulant may comprise a combined treatment of an acidulant and an antioxidant/reducing agent. In such an acidulant combination, i.e. acidulant and an antioxidant/reducing agent, the acidulant may desirably be a modified acidified salt, such as bisulphate of soda as hereinbefore described. Therefore, the acidulant is selected from those that will reduce the pH to at least about 3 or less. In a preferred aspect of the invention the acidulant will reduce the pH to at least about 2.3 or less, preferably 2 or less, preferably to about 1.8 or less and most preferably to about 1.4 or less.

In the composition or kit as hereinbefore described, the antioxidant/redu [symbol] preferentially be one or more of ascorbic acid (vitamin C) and especially salts thereof, such as alkali metal salts, e.g. sodium ascorbate; kojic acid (5-hydroxy-2-(hydroxymethyl)-4H-pyran-4-one), and salts thereof; erythorbic acid and especially salts thereof, such as alkali metal salts, e.g. sodium erythorbate; phenolic antioxidant carboxylic acids, such as a rosmarinic acid ([[3-(3,4-dihydroxyphenyl)-1-oxo-2E-propenyl]oxy]-3,4-dihydroxy-benzenepropanoic acid) and optionally salts thereof, such as alkali metal salts.

The present invention particularly relates to aqueous formulations that include at least one reactive compound, bleaching activator, and inorganic base; and that allow the formulation to be pre-mixed and packaged as a one or two-part kit system. The acidulant composition can be delivered in a wide variety of embodiments, including, but not limited to, foams, sprays, liquids, gels, fogs, aerosols, etc.

In one aspect a method, composition or kit of the present invention comprises an amount of bisulphate of soda from about 1.25% to about 25% (w/v). In one aspect a method, composition or kit of the present invention comprises an amount of citric acid from about 0.1% to about 5% (w/v). In one aspect a method, composition or kit of the present invention an amount of lactic acid may be from about 0.4% to about 20% (w/v). In one aspect a method, composition or kit of the present invention an amount of alkyl (preferably C8) glucoside may be from about 0.2% to about 10% (w/v). In one aspect a method, composition or kit of the present invention an amount of tannic acid may be from about 0.1% to about 15% (w/v). In a preferred aspect of the present invention a method, composition or kit of the present invention comprises an amount of citric acid from about 0.1% to about 5% (w/v), an amount of lactic acid from about 0.4% to about 20% (w/v), an amount of alkyl (preferably C8) glucoside from about 0.2% to about 10% (w/v), and an amount of tannic [symbol] 0.1% to about 15% (w/v).

The method and/or composition of the invention may be used to treat a variety of crops, especially food crops, selected from the group consisting of beet, beans, cucumber, eggplant, pepper, potato and tomato. The method, composition and/or kit are considered to be especially advantageous for the treatment of potato and/or tomato crops.

The invention will now be illustrated by way of example only.

### EXAMPLE 1

### Formulation pHCP

Formulation can be (w/v):
Bisulphate of soda: 1.25%-25%

### Citric Acid: 0.1%-5%

### Lactic Acid: 0.4%-20%

### C8 Alkyl Glucoside: 0.2%-10%

### Tannic Acid: 0.1%-15%

### EXAMPLE 2

### Formulation pHCP

1. Acidified salt—Sodium Hydrogen Sulphate (NaHSO₄), Bisulphate of Soda 0.5%-25%
2. Lactic Acid 0.5%-10%
3. Erythorbic Acid 0.5%-10%
4. Sodium Erythorbate 0.5%-10%
5. Succinic Acid 0.1%-2%
6. C8 Alkyl Glucoside 2%-10%
7. Tannic Acid 1%-15%
8. Ascorbic Acid 1%-20%
9. Rosmarinic Acid 0.25%-1%

### EXAMPLE 3

### Field Trials to Prevent Phytophthora Infestans Infestation on Parsley and Potatoes

After researching the “pros and cons” of the use of available fungicides it was evident farmers/grower of vegetable crops, in particular potatoes and tomatoes want a product which is:

1. Safe and simple to handle—no fumes liberated, no bad odour facilitating a safer and healthier work environment.
2. Provides a barrier against potential fungi and micro-organism infestation to provide long term protection during the development and growth phase of vegetables.
3. Cost effective

### 4. Biodegradable

5. There is no effect on the organoleptic and sensory properties of the Pre and Post-Harvest vegetable with any loss in nutritional value.
6. Does not contain synthetic biocides or antibiotics.

### 7. Non-mutagenic

### 8. Non-lachrymatory

9. Readily dispersible

A product was formulated to deal specifically as a barrier against Phytophthora fungi. After a number of successful greenhouse trials it was decided to conduct a Field Trial to determine its effectiveness against Phytophthora Infestans. The trial was planned for [symbol] The approach was to test against a very sensitive crop and potato plants.

NATRApHASE® pHCP was Formulated as:

| | % Concentration |
|---|---|
| Ingredient | Range w/w |
| Sodium Hydrogen Sulphate | 10-40 |
| Lactic Acid | 5-20 |
| Citric Acid | 2-15 |
| Glucoside Surfactant | 5-20 |

The 2 Chosen Plants were:
1. Parsley because it is a very sensitive crop and
2. Potatoes because it is a crop that is treated regularly (on average 10 to 15 times per season for the control of Phytophthora Infestans).

All the tests were done in practical situations in open fields on big plots of several acres. No phyto-toxicity was evident within the test acreage of parsley and potatoes.

### Trial (1): Preventative Treatment (No Presence of Infestation)

The crops of parsley and potatoes were sprayed with NATRApHASE® pHCP equal to 1 litre per hectare. Over the season 8 treatments were done. There was no sign of Phytophthora Infestans infection and protection was active until harvest. The tubers were [symbol] sign of side effects from the treatment. The leaves remained healthy with no sign of chlorosis.

### Trial (2): Corrective Treatment (Early Evidence of Infestation Presence)

The crops of parsley and potatoes were sprayed with NATRApHASE® pHCP equal to 2 litres per hectare. Over the season 12 treatments were done. NATRApHASE® pHCP stopped the growth of the Phytophthora Infestans infection and prevented further infestation until harvest. The Tubers were healthy with no sign of side effects from the treatment. The leaves remained healthy with no sign of chlorosis.

### Trial (3):

In 2012 season the product was applied by farmers and the results were/are very positive.

There is also strong interest from organic farmers for whom it seems to be one of the rare remaining possibilities to control the disease.

### CONCLUSION

1. These trials indicate quite strongly the effectiveness of NATRApHASE® pHCP as a safe and easy to use alternative to current available fungicides inhibiting fungal infection.

2. It is very important to begin treatment as soon as presence of fungi is evident—when first symptoms are visible. Based on historic data, treatment should perhaps be applied prior to fungal infection occurring.

3. Spraying needs to be done in an orderly manner ensuring coverage is evenly managed.
4. The trial demonstrated that NATRApHASE® pHCP is a very safe product to use, easy to prepare by handlers and cost effective compared to the more sophisticated fungicides available on the market.

1. A method of treating a crop for the alleviation or prevention of a pest infestation, said method comprises the pre-harvest application to the crop of a composition comprising an acidulant.

2. A method according to claim 1 which comprises applying the composition to the crop about 2 to 6 weeks prior to harvest.

3-4. (canceled)

5. A method according to claim 1 wherein the pest infestation is an arachnid infestation.

6-7. (canceled)

8. A method according to claim 1 wherein the pest infestation is a fungal infestation.

9-12. (canceled)

13. A method according to claim 1 which comprises applying the composition as a prophylactic measure.

14-17. (canceled)

18. A method according to claim 1 wherein the concentration of the acidulant is from about 0.1% to about 25% (w/v).

19-21. (canceled)

22. A method according to claim 1 wherein the acidulant is a modified acidified salt.

23. A method according to claim 22 wherein the modified acidified salt is acidified sodium chloride.

24. A method according to claim 1 wherein the composition includes an antioxidant/reducing agent.

25. A method according to claim 24 wherein the antioxidant/reducing agent is selected from one or more of ascorbic acid (vitamin C) and especially salts thereof, such as alkali metal salts, e.g. sodium ascorbate; kojic acid (5-hydroxy-2-(hydroxymethyl)-4H-pyran-4-one) and salts thereof; erythorbic acid and especially salts thereof, such as alkali metal salts, e.g. sodium erythorbate; phenolic antioxidant carboxylic acids, such as a rosmarinic acid ([[3-(3,4-dihydroxyphenyl)-1-oxo-2E-propenyl]oxy]-3,4-dihydroxy-benzenepropanoic acid) and optionally salts thereof, such as alkali metal salts.

26. (canceled)

27. A method according to claim 24 wherein the amount of antioxidant/reducing agent is from about 0.25% (w/v) to about 10% (w/v).

28. A method according to claim 1 wherein the composition includes one or more enzyme inhibitors.

29. A method according to claim 1 wherein the composition includes a diluent.

30-33. (canceled)

34. A composition suitable for the treatment or prevention of a pest infestation of a crop, said composition comprising an acidulant present in an amount from about from about 0.1% to about 25% (w/v).

35. A composition according to claim 34 wherein the pest infestation is an arachnid infestation.

36-37. (canceled)

38. A composition according to claim 34 wherein the pest infestation is a fungal infestation.

39-42. (canceled)

43. A composition according to claim 34 wherein the acidulant is a modified acidified salt.

44. (canceled)

45. A composition according to claim 43 wherein the antioxidant/reducing agent is one or more of ascorbic acid (vitamin C) and especially salts thereof, such as alkali metal salts, e.g. sodium ascorbate; kojic acid (5-hydroxy-2-(hydroxymethyl)-4H-pyran-4-one), and salts thereof; erythorbic acid and especially salts thereof, such as alkali metal salts, e.g. sodium erythorbate; phenolic antioxidant carboxylic acids, such as a rosmarinic acid ([[3-(3,4-dihydroxyphenyl)-1-oxo-2E-propenyl]oxy]-3,-dihydroxy-benzenepropanoic acid) and optionally salts thereof, such as alkali metal salts.

46. (canceled)

47. A composition according to claim 34 wherein the composition includes a diluent.

48-52. (canceled)

53. A kit suitable for the treatment or prevention of a pest infestation of a crop, the kit comprising a low concentration acidulant.

54-64. (canceled)
